(19) United States
(12) Patent Application Publication
(10) Pub. No.: US 2026/0280937 A1
(43) Pub. Date: Sep. 17, 2026

(54) Channel Estimation by Utilizing Cyclic Redundancy Check Proof Data

(71) Applicant: Dell Products L.P., Round Rock, TX (US)

(72) Inventors: Eran Goldstein, Montreal (CA); Mohammed Abdelsadek, Kanata (CA); Jayaram Venguduswamy Srinivasan, Kanata (CA)

(21) Appl. No.: 19/080,254

(22) Filed: Mar. 14, 2025

(51) Int. Cl. H04L 25/02; H04L 5/00; H04L 27/26

(52) U.S. Cl. CPC H04L 25/0202; H04L 5/0005

(57) ABSTRACT

A system can, after initializing current symbols as the reference symbols, perform at least one iteration of, performing channel estimation over the current symbols, to produce a current channel estimation, decoding new data symbols of the data symbols that satisfy a proximity criterion with respect to the current symbols based on the current channel estimation, and to produce decoded new data symbols, wherein an iteration of the at least one iteration has not yet been performed for the new data symbols, and based on determining that a cyclic redundancy check for the decoded new data symbols passes, and based on determining that there are still symbols for which channel estimation has not yet been performed, setting the current symbols to be the decoded new data symbols, and performing another iteration. The system can adapt broadband cellular transmission parameters based on the cumulative channel estimation.

### BACKGROUND

A base station can facilitate broadband cellular communications with user equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, in a broadband cellular communication session, receive a protocol data unit, wherein the protocol data unit comprises symbols, and wherein the symbols comprise reference symbols and data symbols. The system can, while there are still symbols of the symbols for which channel estimation has not yet been performed, and after initializing current symbols as the reference symbols, perform at least one iteration of, performing channel estimation over the current symbols, to produce a current channel estimation, and adding the current channel estimation to a cumulative channel estimation, equalizing and decoding new data symbols of the data symbols that satisfy a proximity criterion with respect to the current symbols based on the current channel estimation, and to produce decoded new data symbols, wherein an iteration of the at least one iteration has not yet been performed for the new data symbols, and based on determining that a cyclic redundancy check for the decoded new data symbols passes, and based on determining that there are still symbols for which channel estimation has not yet been performed, setting the current symbols to be the decoded new data symbols, and performing another iteration of the at least one iteration. The system can adapt transmission parameters for the broadband cellular communication session based on the cumulative channel estimation to produce a modified broadband cellular communication session. The system can transmit data via the modified broadband cellular communication session.

An example method can comprise, for a protocol data unit that comprises symbols, wherein the symbols comprise reference symbols and data symbols, wherein the protocol data unit is received as part of broadband cellular communications, while there are symbols of the symbols for which channel estimation has not yet been performed, and after initializing current symbols as the reference symbols, performing at least one iteration of performing, by a system comprising at least one processor, channel estimation over the current symbols, to produce a channel estimation, and adding the channel estimation to a cumulative channel estimation, equalizing and decoding, by the system, new data symbols of the data symbols that satisfy a proximity criterion with respect to the current symbols based on the channel estimation, and to produce decoded new data symbols, wherein an iteration of the at least one iteration has not yet been performed for the new data symbols, and based on determining that a cyclic redundancy check for the decoded new data symbols passes, and based on determining that there are the symbols for which channel estimation has not yet been performed, setting, by the system, the current symbols to be the decoded new data symbols, and performing another iteration of the at least one iteration. The method can further comprise, adapting, by the system, transmission parameters for the broadband cellular communications based on the cumulative channel estimation.

An example non-transitory computer-readable medium can comprise instructions that, in response to execution, cause a system comprising a processor to perform operations. These operations can comprise, for a protocol data unit that comprises symbols, wherein the symbols comprise reference symbols and data symbols, wherein the protocol data unit is received as part of broadband cellular communications, while there are symbols of the symbols for which channel estimation has not yet been performed, and after initializing current symbols as the reference symbols, performing at least one iteration of, performing channel estimation over the current symbols, to produce a channel estimation, and adding the channel estimation to a cumulative channel estimation, equalizing and decoding new data symbols of the data symbols that satisfy a proximity criterion with respect to the current symbols based on the channel estimation, and to produce decoded new data symbols, wherein an iteration of the at least one iteration has not yet been performed for the new data symbols, and based on determining that a cyclic redundancy check for the decoded new data symbols passes, and based on determining that there are the symbols for which channel estimation has not yet been performed, setting the current symbols to be the decoded new data symbols, and performing another iteration of the at least one iteration. These operations can further comprise adapting transmission parameters for the broadband cellular communications based on the cumulative channel estimation.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate channel estimation by utilizing CRC proof data, in accordance with an embodiment of this disclosure;

FIG. 2 illustrates an example of reference symbols (RSs) in a protocol data unit (PDU), and that can facilitate channel estimation by utilizing CRC proof data, in accordance with an embodiment of this disclosure;

FIG. 3 illustrates another example of RSs in a protocol data unit (PDU), and that can facilitate channel estimation by utilizing CRC proof data, in accordance with an embodiment of this disclosure;

FIG. 4 illustrates an example of a channel estimation, and that can facilitate channel estimation by utilizing CRC proof data, in accordance with an embodiment of this disclosure;

FIG. 5 illustrates an example process flow that can facilitate channel estimation by utilizing CRC proof data, in accordance with an embodiment of this disclosure;

FIG. 6 illustrates another example process flow that can facilitate channel estimation by utilizing CRC proof data, in accordance with an embodiment of this disclosure;

FIG. 7 illustrates another example process flow that can facilitate channel estimation by utilizing CRC proof data, in accordance with an embodiment of this disclosure;

FIG. 8 illustrates another example process flow that can facilitate channel estimation by utilizing CRC proof data, in accordance with an embodiment of this disclosure; and

FIG. 9 illustrates an example block diagram of a computer operable to execute an embodiment of this disclosure.

### DETAILED DESCRIPTION

### Overview

While the examples described herein generally relate to fifth generation (5G) broadband cellular network technologies, it can be appreciated that they can be applied to other types of broadband cellular network technologies.

Regarding broadband cellular communications, in general, pilots, or reference symbols (RS), can be used in communication to allow the receiver to estimate the channel, and accordingly equalize the data transmission. As the channel changes over time (which can be referred to as Doppler spread, or the coherence time) the channel estimation can lose its relevancy. Consequently, equalized data symbols can be more noisy, less accurate, and therefore throughput can be reduced due to block error rate (BLER) and modulation and coding scheme (MCS) reduction.

Given these problems according to the present techniques, updated reference symbols can be used to correctly equalize data symbols in fast changing radiofrequency (RF) channels.

Prior approaches, such as according to a Third Generation Partnership Project (3GPP) protocol, can involve increasing the rate at which pilot symbols are transmitted. A 3GPP can allow 1, 2, 3 or 4 reference symbols per slot. The disadvantage of these prior approaches can be that, where—more symbols are used for pilots, then less symbols are available for data, and therefore there is reduced spectral efficiency.

In 5G technologies, data can be protected with a CRC sequence per code block. Some of the code blocks can be closer (or simultaneous) to the reference symbols. Equalization of those code blocks can have better performance, and therefore be more likely to succeed to pass the CRC check.

There are generally two prior approaches where data can be utilized to improve symbols equalization—turbo equalization and blind equalization. The present techniques offer superior performance relative to these two prior approaches in a scenario of changing channel conditions.

The present techniques can be implemented using the following example steps:
1. Perform channel estimation over the pilots RS symbols.
2. Use the obtained channel estimation to equalize and decode the data symbols closest to the reference symbol.
3. If the CRC passes, use the acquired data bits to regenerate the transmitted symbols, performing the same processing chain as performed on the transmitter side:
   a. CRC attachment;
   b. Encoding;
   c. Scrambling;
   d. Rate matching; and
   e. Modulating (bits into symbols).
4. Use the modulated transmitted symbols as a reference, and the received symbols as the received pilots to perform an additional channel estimation that further from the original channel estimation in Step 1.
5. Use the additional channel estimation to extrapolate the channel estimation into a new symbol or symbols and repeat the process.

By following these steps, the number of pilots (RS) can be reduced relative to other approaches, and still an up-to-date version of the channel estimation can be used to equalize the data per symbol. Those RS can be replaced by data symbols and thus increase the spectral efficiency.

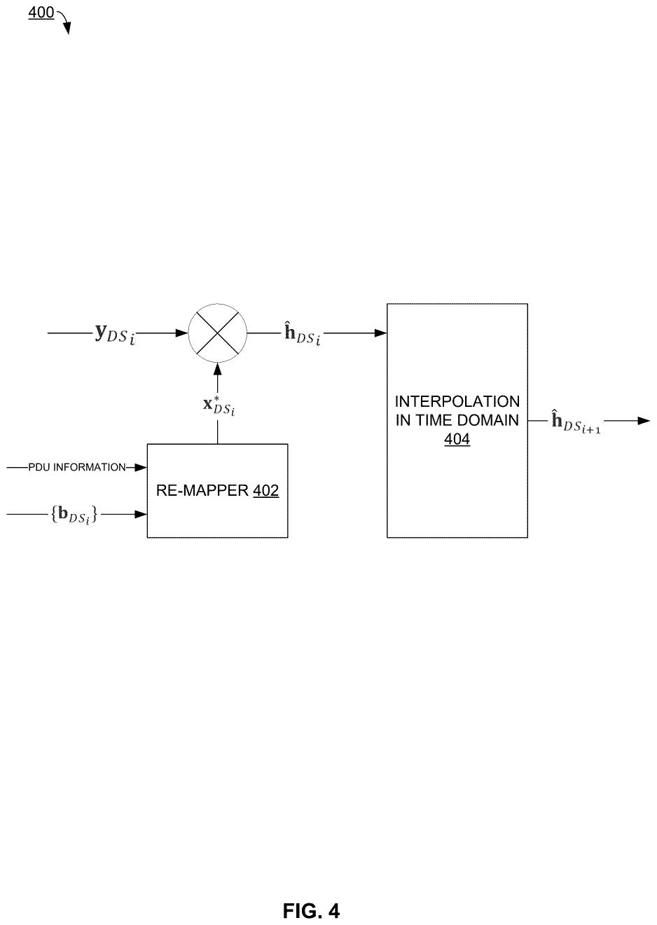

In different examples, different techniques can be used to perform a channel estimation based on reference symbols. One example is a least squares (LS) technique, which can generally comprise multiplying the received pilots with the conjugate of the reference in 5G (see FIG. 4).

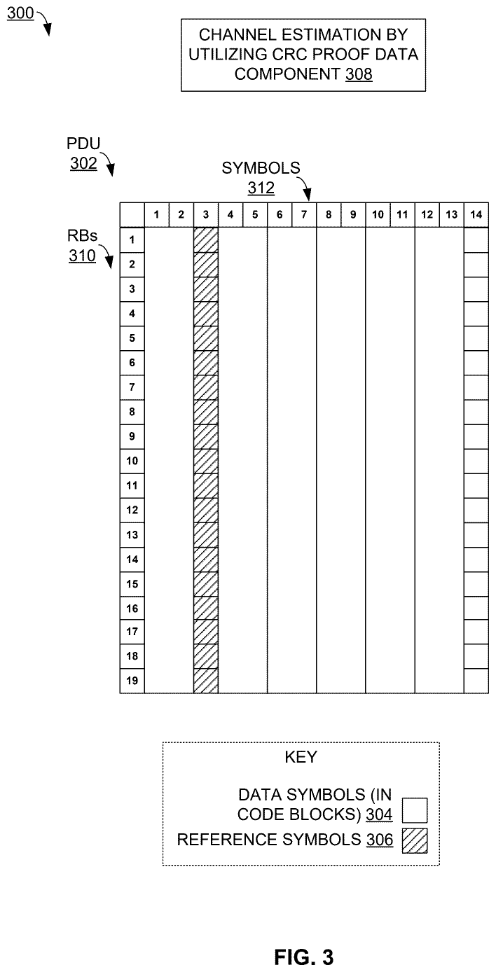

Some of the present techniques can work without any changes to prior 3GPP specifications to reduce the number of RS symbols and thus increase spectral efficiency. However, the number of code blocks per symbol may differ (see FIG. 3). Depending on the configuration (e.g., number of resource blocks (RBs) used and the MCS), one code block can take many symbols, thus reducing efficiency. Additionally, in 5G, the number of DMRS can be preconfigured and not changed per scheduling, while the number of code blocks per symbol can be changed per scheduling. However, it can be that the channel update is most beneficial at a high MCS, where static DMRS has less of an impact.

For example, 2 layers 25 resource blocks (RBs) MCS 256 quadrature amplitude modulation (QAM) 90% can carry 4,320 bits. That is, N_bits=25*12*2*0.9*8=4,320 bits.

Since the maximum number of bits can be 8,114 per code block in 5G, in this example, there is roughly half a code block for each symbol. In other words, a new channel estimation can be made every 2 symbols, which represents an improvement over prior approaches.

In cases where a number of scheduled RBs is low, or MCS is low and the present techniques are implemented, a 3GPP protocol can be adjusted by:
Decreasing the maximal code block size. In that way the code block could fit in fewer symbols;
Adding the number of pilots in the scheduling information; and/or
Adding a new configuration that allows the receiver (UE) or transmitter, to determine the number of DMRS needed based on the channel estimation achievable according to the present techniques.

The present techniques can facilitate the regeneration of the ideal transmitted signal from the decoded data by following the procedures implemented in the transmitter, i.e., CRC attachment, encoding, scrambling, etc. This mechanism, which can be referred to as remapping, can be available in L1 accelerator cards as it can be needed for receivers with successive/serial-interference cancellation (SIC). SIC can be used to separate and decode signals from multiple users or layers that are transmitted simultaneously on the same time-frequency resources in multiple-input multiple-output (MIMO) scenarios. Therefore, this remapping functionality can be utilized for the present techniques without incurring more costs to L1 accelerator cards.

### Example Architectures, Etc.

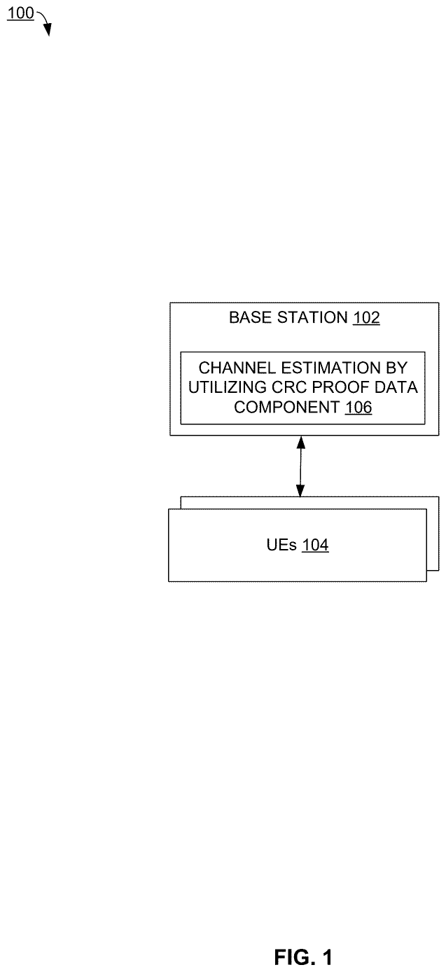

FIG. 1 illustrates an example system architecture 100 that can facilitate channel estimation by utilizing CRC proof data, in accordance with an embodiment of this disclosure.

System architecture 100 comprises base station 102, UE(s) 104, and channel estimation by utilizing CRC proof data component 106.

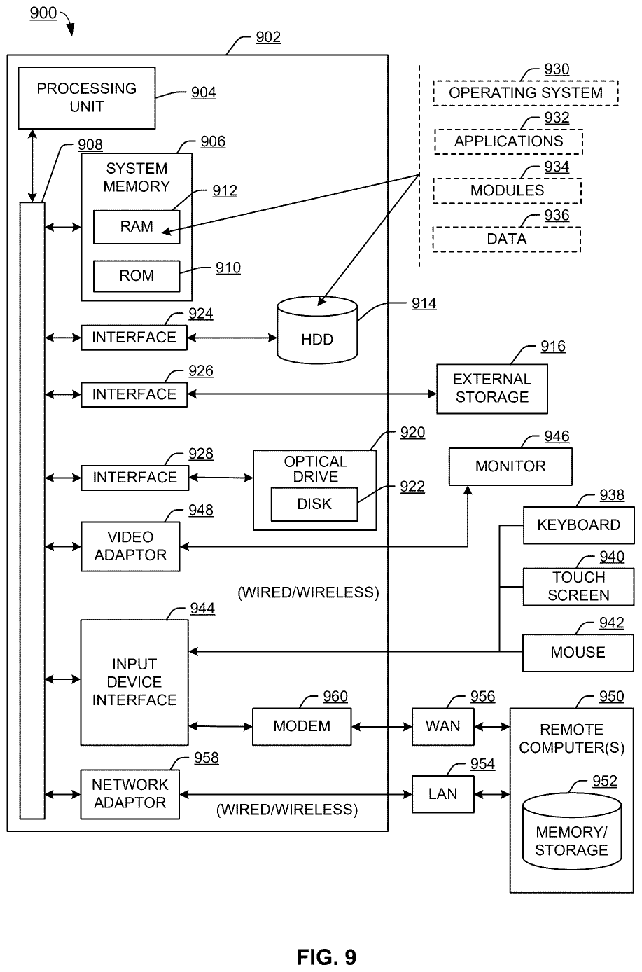

Each of base station 102 and/or UE(s) 104 can be implemented with part(s) of computing environment 900 of FIG. 9.

A UE of UE(s) 104 can send communications (e.g., physical uplink shared channel (PUSCH) communications) to base station 102 via a broadband cellular network. Channel estimation by utilizing CRC proof data component 106 can use these communications to perform channel estimation, such as in fast-changing conditions (e.g., where the UE is rapidly physically moving). This can involve performing channel estimation for the pilot signals, and then iteratively performing channel estimation on neighboring data symbols.

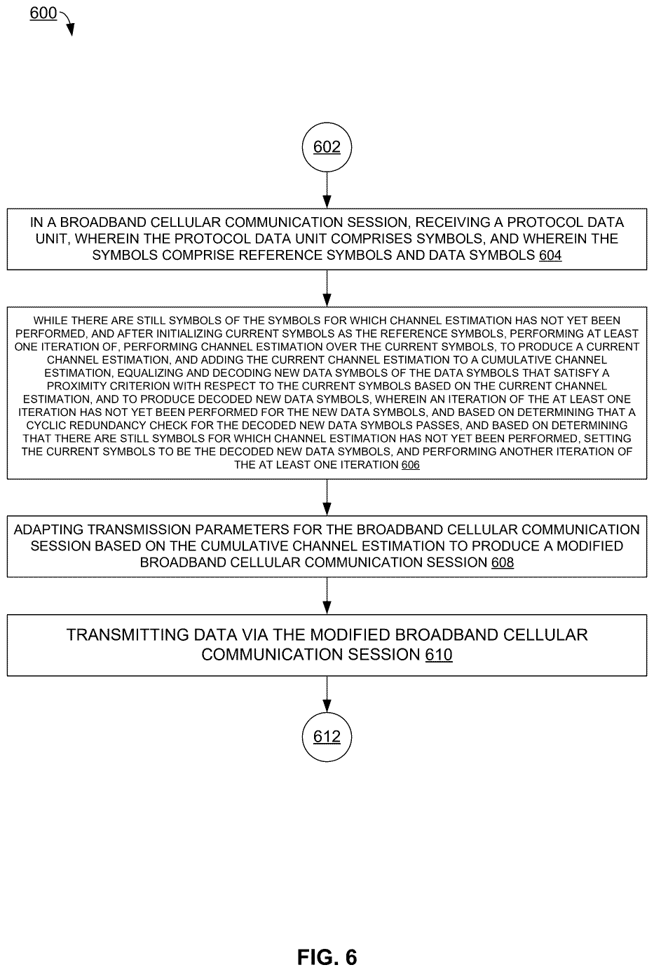

In some examples, channel estimation by utilizing CRC proof data component 106 can implement part(s) of the process flows of FIGS. 6-8 to implement channel estimation by utilizing CRC proof data.

It can be appreciated that system architecture 100 is one example system architecture for channel estimation by utilizing CRC proof data, and that there can be other system architectures that facilitate channel estimation by utilizing CRC proof data.

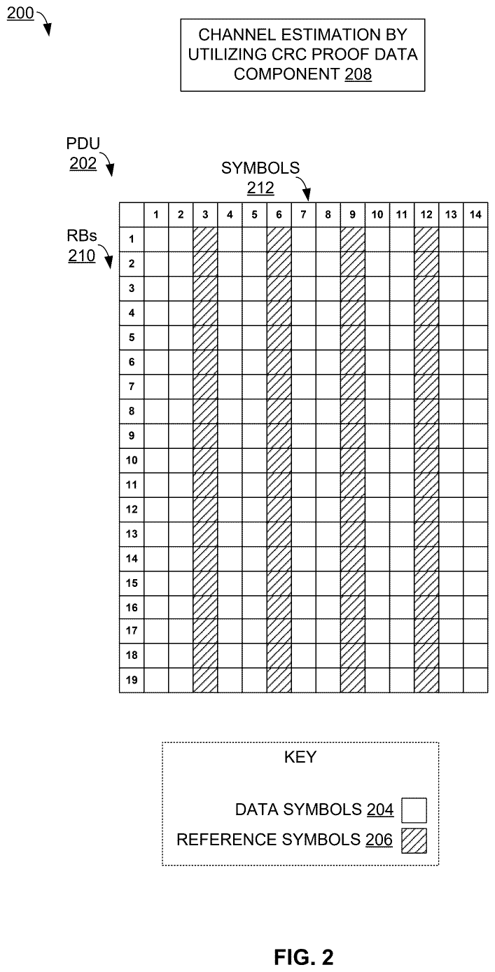

FIG. 2 illustrates an example 200 of reference symbols (RSs) in a protocol data unit (PDU), and that can facilitate channel estimation by utilizing CRC proof data, in accordance with an embodiment of this disclosure. In some examples, part(s) of example 200 can be implemented by part(s) of system architecture 100 of FIG. 1 to facilitate channel estimation by utilizing CRC proof data.

Example 200 comprises PDU 202, data symbols 204, reference symbols 206, channel estimation by utilizing CRC proof data component 208 (which can be similar to channel estimation by utilizing CRC proof data component 106 of FIG. 1), RBs 210, and symbols 212.

Reference symbols 206 can be used to obtain a channel estimation and to interpolate the estimation over the data symbols. In general, with a PDU, the more RS symbols, the less data is transmitted.

FIG. 3 illustrates another example of RSs in a protocol data unit (PDU), and that can facilitate channel estimation by utilizing CRC proof data, in accordance with an embodiment of this disclosure. In some examples, part(s) of example 300 can be implemented by part(s) of system architecture 100 of FIG. 1 to facilitate channel estimation by utilizing CRC proof data.

Example 300 comprises PDU 302, data symbols (in code blocks) 304, reference symbol 306, channel estimation by utilizing CRC proof data component 308 (which can be similar to channel estimation by utilizing CRC proof data component 106 of FIG. 1), RBs 310, and symbols 312.

Relative to example 200 of FIG. 2, fewer reference symbols are used, which leaves more room for data in a PDU, thus increasing communications throughput. The present techniques for channel estimation can be performed by channel estimation by utilizing CRC proof data component 308 to facilitate channel estimation with this smaller number of reference symbols.

In example 300, using only one RS symbol allows more room for data. Each code block can be checked with a CRC, and if it passes, it can be used for a channel estimation (ch. est) update and improvement.

FIG. 4 illustrates an example 400 of a channel estimation, and that can facilitate channel estimation by utilizing CRC proof data, in accordance with an embodiment of this disclosure. In some examples, part(s) of example 400 can be implemented by part(s) of system architecture 100 of FIG. 1 to facilitate channel estimation by utilizing CRC proof data.

Example 400 comprises re-mapper 402 and interpolation in time domain 404. Example 400 illustrates an example of channel estimation using a LS technique on decoded data, where y_{DSi} is the received data symbol i, {b_{DS}_{ᵢ}} are the decoded bits, x*_{DS}_{ᵢ} * is the conjugate of the remapped symbols, and ĥ_{DSi} is the estimated channel of that data symbol (DS).

### Example Process Flows

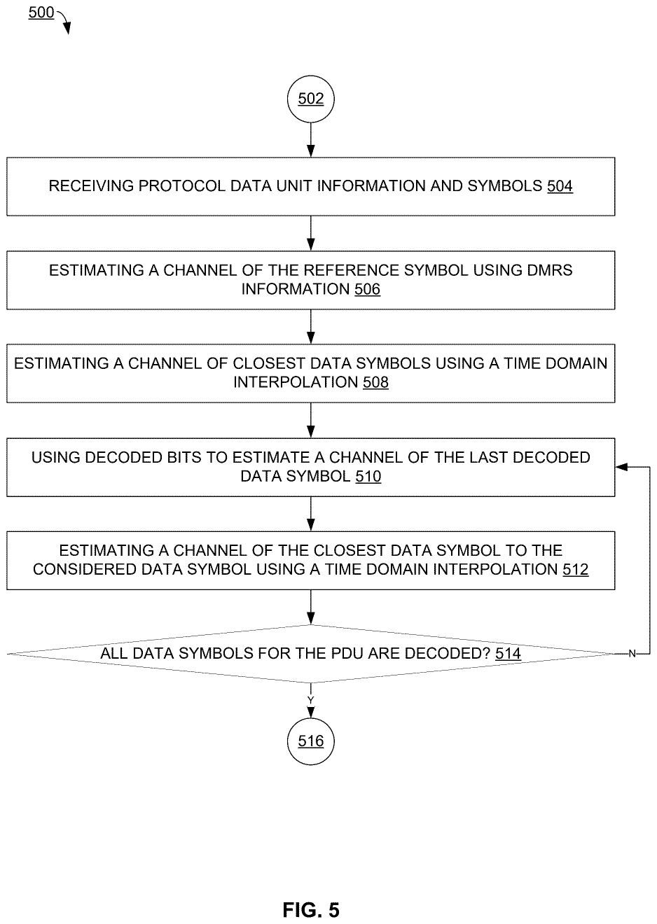

FIG. 5 illustrates another example process flow 500 that can facilitate channel estimation by utilizing CRC proof data, in accordance with an embodiment of this disclosure.

In some examples, one or more embodiments of process flow 500 can be implemented by channel estimation by utilizing CRC proof data component 106 of FIG. 1, or computing environment 900 of FIG. 9.

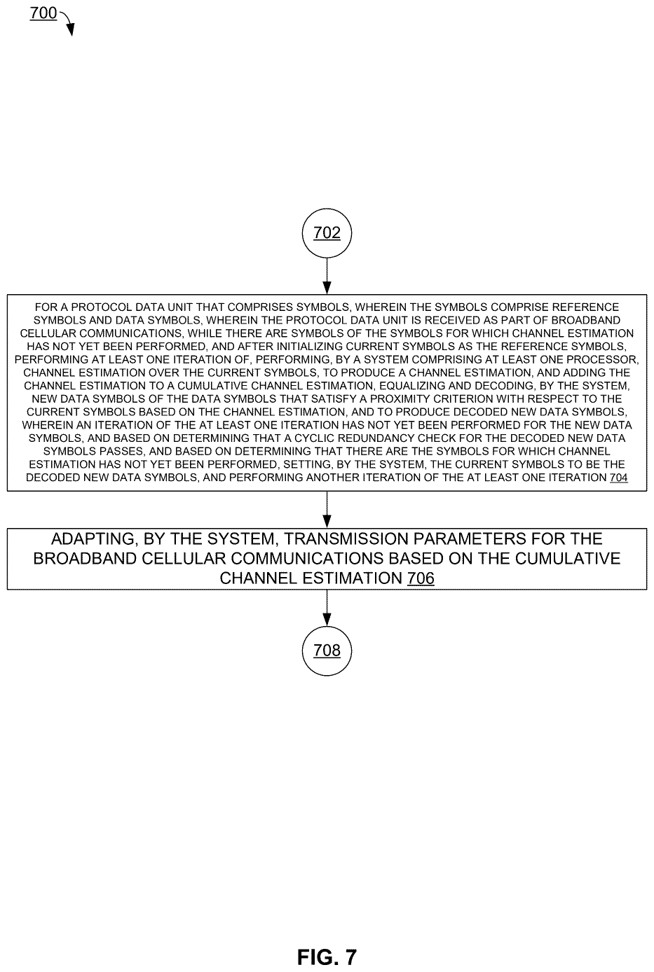

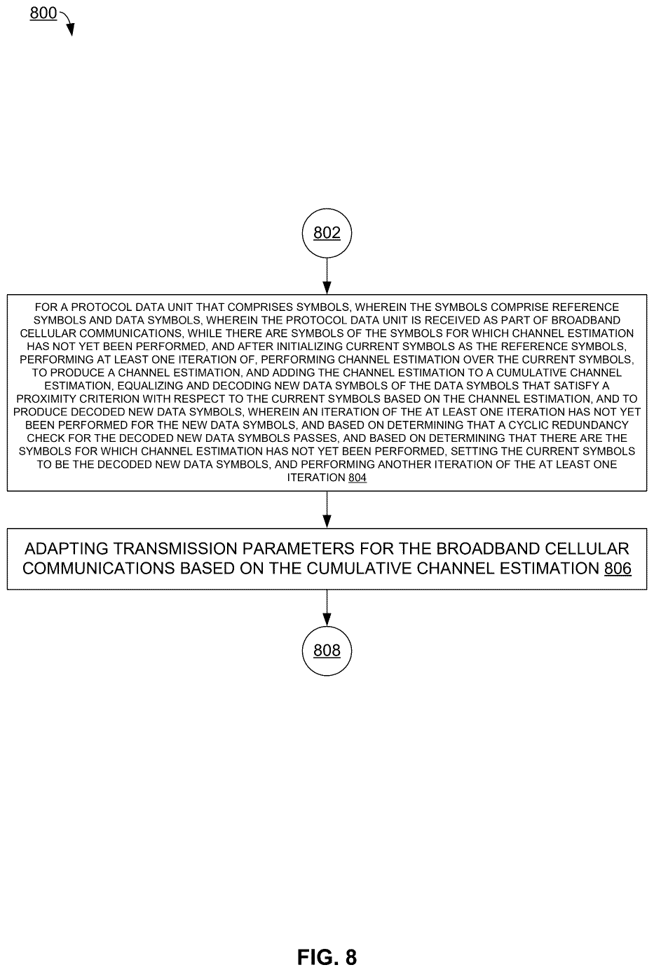

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, and/or process flow 800 of FIG. 8.

In process flow 500, the data symbol is an orthogonal frequency division multiplexing (OFDM) data symbol, and the RS is a demodulation reference signal (DMRS) symbol.

Process flow 500 begins with 502, and moves to operation 504.

Operation 504 depicts receiving protocol data unit information and symbols.

Operation 506 depicts estimating a channel of the reference symbol using DMRS information.

Operation 508 depicts estimating a channel of closest data symbols using a time domain interpolation.

Operation 510 is reached from operation 508, or from operation 514 where in operation it is determined that all data symbols for the PDU are not decoded. Operation 510 depicts using decoded bits to estimate a channel of the last decoded data symbol.

Operation 512 depicts estimating a channel of the closest data symbol to the considered data symbol using a time domain interpolation.

Operation 514 depicts determining whether all data symbols for the PDU are decoded.

Where in operation 514 it is determined that all data symbols for the PDU are decoded, process flow 500 moves to 516, where process flow 500 ends. Instead, where in operation it is determined that all data symbols for the PDU are not decoded, process flow 500 returns to operation 510.

FIG. 6 illustrates another example process flow 600 that can facilitate channel estimation by utilizing CRC proof data, in accordance with an embodiment of this disclosure. In some examples, one or more embodiments of process flow 600 can be implemented by channel estimation by utilizing CRC proof data component 106 of FIG. 1, or computing environment 900 of FIG. 9.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, and/or process flow 800 of FIG. 8.

Process flow 600 begins with 602, and moves to operation 604.

Operation 604 depicts, in a broadband cellular communication session, receiving a protocol data unit, wherein the protocol data unit comprises symbols, and wherein the symbols comprise reference symbols and data symbols. Using the example of FIG. 1, process flow 600 can be implemented by base station 102 in communicating with a UE of UEs 104.

In some examples, the reference symbols comprise demodulation reference signal information of the broadband cellular communication session. In some examples, the data symbols comprise orthogonal frequency division multiplexing data symbols.

After operation 604, process flow 600 moves to operation 606.

Operation 606 depicts, while there are still symbols of the symbols for which channel estimation has not yet been performed, and after initializing current symbols as the reference symbols, performing at least one iteration of, performing channel estimation over the current symbols, to produce a current channel estimation, and adding the current channel estimation to a cumulative channel estimation, equalizing and decoding new data symbols of the data symbols that satisfy a proximity criterion with respect to the current symbols based on the current channel estimation, and to produce decoded new data symbols, wherein an iteration of the at least one iteration has not yet been performed for the new data symbols, and based on determining that a cyclic redundancy check for the decoded new data symbols passes, and based on determining that there are still symbols for which channel estimation has not yet been performed, setting the current symbols to be the decoded new data symbols, and performing another iteration of the at least one iteration.

That is, as long as there are more symbols in the PDU to analyze, perform an iteration of performing channel estimation over some symbols, equalize and decode the data symbols, and if the CRC passes and there are more symbols then perform another iteration.

In some examples operation 606 comprises, based on the determining that the cyclic redundancy check for the decoded new data symbols passes, performing, on the decoded new data symbols, cyclic redundancy check attachment, encoding, scrambling, rate matching, and modulating of bits to produce modulated transmitted symbols, wherein the setting of the current symbols to be the decoded new data symbols comprises setting the current symbols to be the modulated transmitted symbols. That is, where a CRC passes, the acquired data bits can be used to regenerate the transmitted symbols, and a processing chain similar to that performed on the transmitter side can be performed: CRC attachment, encoding, scrambling, rate matching, and modulating (bits into symbols).

In some examples, the performing of the channel estimation is based on a time domain interpolation of the protocol data unit. In some examples, the time domain interpolation is performed on at least some of the data symbols. In some examples, the time domain interpolation is omitted with respect to the reference symbols. This can be implemented in a similar manner as operation 512 of FIG. 5.

In some examples, the performing of the channel estimation is based on a least squares estimation.

After operation 606, process flow 600 moves to operation 608.

Operation 608 depicts adapting transmission parameters for the broadband cellular communication session based on the cumulative channel estimation to produce a modified broadband cellular communication session. That is, operation 608 can comprise changing the transmission parameters based on the channel estimation of operation 606.

After operation 608, process flow 600 moves to operation 610.

Operation 610 depicts transmitting data via the modified broadband cellular communication session. That is, further cellular communications between base station 102 of FIG. 1 and a UE of UEs 104 can be performed using the new transmission parameters of operation 606.

After operation 610, process flow 600 moves to 612, where process flow 600 ends.

FIG. 7 illustrates an example process flow 700 that can facilitate channel estimation by utilizing CRC proof data, in accordance with an embodiment of this disclosure. In some examples, one or more embodiments of process flow 700 can be implemented by channel estimation by utilizing CRC proof data component 106 of FIG. 1, or computing environment 900 of FIG. 9.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, and/or process flow 800 of FIG. 8.

Process flow 700 begins with 702, and moves to operation 704.

Operation 704 depicts for a protocol data unit that comprises symbols, wherein the symbols comprise reference symbols and data symbols, wherein the protocol data unit is received as part of broadband cellular communications, while there are symbols of the symbols for which channel estimation has not yet been performed, and after initializing current symbols as the reference symbols, performing at least one iteration of, performing, by a system comprising at least one processor, channel estimation over the current symbols, to produce a channel estimation, and adding the channel estimation to a cumulative channel estimation, equalizing and decoding, by the system, new data symbols of the data symbols that satisfy a proximity criterion with respect to the current symbols based on the channel estimation, and to produce decoded new data symbols, wherein an iteration of the at least one iteration has not yet been performed for the new data symbols, and based on determining that a cyclic redundancy check for the decoded new data symbols passes, and based on determining that there are the symbols for which channel estimation has not yet been performed, setting, by the system, the current symbols to be the decoded new data symbols, and performing another iteration of the at least one iteration.

In some examples, operation 704 can be implemented in a similar manner as operations 604-606 of FIG. 6.

In some examples, the protocol data unit is a first protocol data unit, wherein the cyclic redundancy check is a first cyclic redundancy check, and further comprising halting, by the system, performing channel estimation for a second protocol data unit based on determining that a second cyclic redundancy check fails for a part of the second protocol data unit. That is, if CRC fails for a PDU while performing these iterations on it, it can be that performing these iterations is halted (since there is not a passing CRC with which to perform an additional operation).

In some examples, the protocol data unit is received on a physical uplink shared channel of the broadband cellular communications. In some examples, the protocol data unit is received on a physical downlink shared channel of the broadband cellular communications. That is, physical data channels (e.g., PUSCH/PDSCH) can utilize pilots/reference signals (e.g., DMRS) to demodulate a signal at a receiver.

In some examples, operation 704 comprises communicating, by the system, a number of the reference symbols per protocol data unit via scheduling information. That is, a number of pilot symbols to be used can be included in scheduling information.

In some examples, the protocol data unit is a first protocol data unit, the reference symbols are first reference symbols, and operation 706 comprises determining, by the system, a second number of second reference signals to use with a second protocol data unit, based on based on the cumulative channel estimation, wherein the second number differs from a first number of first reference signals of the first protocol data unit.

In some examples, the protocol data unit is a first protocol data unit, the reference symbols are first reference symbols, and operation 706 comprises receiving, by the system, a second number of second reference signals to use with a second protocol data unit, based on based on the cumulative channel estimation, wherein the second number differs from a first number of first reference signals of the first protocol data unit. That is, there can be a configuration that allows a receiver (e.g., UE) or transmitter to determine a number of DMRS to use based on channel estimation according to the present techniques, and to modify the number of DMRS to use.

After operation 704, process flow 700 moves to operation 706.

Operation 706 depicts adapting, by the system, transmission parameters for the broadband cellular communications based on the cumulative channel estimation. In some examples, operation 706 can be implemented in a similar manner as operations 608-610 of FIG. 6.

After operation 706, process flow 700 moves to 708, where process flow 700 ends.

FIG. 8 illustrates an example process flow 800 that can facilitate channel estimation by utilizing CRC proof data, in accordance with an embodiment of this disclosure. In some examples, one or more embodiments of process flow 800 can be implemented by channel estimation by utilizing CRC proof data component 106 of FIG. 1, or computing environment 900 of FIG. 9.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, and/or process flow 700 of FIG. 7.

Process flow 800 begins with 802, and moves to operation 804.

Operation 804 depicts, for a protocol data unit that comprises symbols, wherein the symbols comprise reference symbols and data symbols, wherein the protocol data unit is received as part of broadband cellular communications, while there are symbols of the symbols for which channel estimation has not yet been performed, and after initializing current symbols as the reference symbols, performing at least one iteration of, performing channel estimation over the current symbols, to produce a channel estimation, and adding the channel estimation to a cumulative channel estimation, equalizing and decoding new data symbols of the data symbols that satisfy a proximity criterion with respect to the current symbols based on the channel estimation, and to produce decoded new data symbols, wherein an iteration of the at least one iteration has not yet been performed for the new data symbols, and based on determining that a cyclic redundancy check for the decoded new data symbols passes, and based on determining that there are the symbols for which channel estimation has not yet been performed, setting the current symbols to be the decoded new data symbols, and performing another iteration of the at least one iteration. In some examples, operation 804 can be implemented in a similar manner as operations 608-610 of FIG. 6.

In some examples, the at least one iteration comprises remapping the current symbols. In some examples, the remapping is performed by a layer 1 hardware accelerator card. In some examples, the layer 1 hardware accelerator card is configured to perform remapping as part of performing successive-interference cancellation or as part of performing serial-interference cancellation. That is, remapping can comprise the regeneration of the ideal transmitted signal from the decoded data by following the procedures implemented in the transmitter, i.e., CRC attachment, encoding, scrambling, etc. This mechanism can be available in L1 accelerator cards as it can be needed for receivers with successive/serial-interference cancellation (SIC). SIC can be used to separate and decode signals from multiple users or layers that are transmitted simultaneously on the same time-frequency resources in multiple-input multiple-output (MIMO) scenarios. Therefore, this remapping functionality can be utilized for the present techniques without incurring more costs to L1 accelerator cards.

In some examples, operation 804 comprises, based on the determining that the cyclic redundancy check for the decoded new data symbols passes, performing cyclic redundancy check attachment, encoding, scrambling, rate matching, and modulating, to produce modulated transmitted symbols, wherein the setting of the current symbols to be the decoded new data symbols comprises setting the current symbols to be the modulated transmitted symbols.

After operation 804, process flow 800 moves to operation 806.

Operation 806 depicts adapting transmission parameters for the broadband cellular communications based on the cumulative channel estimation. In some examples, operation 806 can be implemented in a similar manner as operations 608-610 of FIG. 6.

After operation 806, process flow 800 moves to 808, where process flow 800 ends.

### Example Operating Environment

In order to provide additional context for various embodiments described herein, FIG. 9 and the following discussion are intended to provide a brief, general description of a suitable computing environment 900 in which the various embodiments of the embodiment described herein can be implemented.

For example, parts of computing environment 900 can be used to implement one or more embodiments of base station 102 and/or UE(s) 104.

In some examples, computing environment 900 can implement one or more embodiments of the process flows of FIGS. 6-8 to facilitate channel estimation by utilizing CRC proof data.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a nonvolatile storage such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the . NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples, and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can

include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
in a broadband cellular communication session, receiving a protocol data unit, wherein the protocol data unit comprises symbols, and wherein the symbols comprise reference symbols and data symbols;
while there are still symbols of the symbols for which channel estimation has not yet been performed, and after initializing current symbols as the reference symbols, performing at least one iteration of,
performing channel estimation over the current symbols, to produce a current channel estimation, and adding the current channel estimation to a cumulative channel estimation,
equalizing and decoding new data symbols of the data symbols that satisfy a proximity criterion with respect to the current symbols based on the current channel estimation, and to produce decoded new data symbols, wherein an iteration of the at least one iteration has not yet been performed for the new data symbols, and
based on determining that a cyclic redundancy check for the decoded new data symbols passes, and based on determining that there are still symbols for which channel estimation has not yet been performed, setting the current symbols to be the decoded new data symbols, and performing another iteration of the at least one iteration;
adapting transmission parameters for the broadband cellular communication session based on the cumulative channel estimation to produce a modified broadband cellular communication session; and
transmitting data via the modified broadband cellular communication session.

2. The system of claim 1, wherein the operations further comprise:
based on the determining that the cyclic redundancy check for the decoded new data symbols passes, performing, on the decoded new data symbols, cyclic redundancy check attachment, encoding, scrambling, rate matching, and modulating of bits to produce modulated transmitted symbols,
wherein the setting of the current symbols to be the decoded new data symbols comprises setting the current symbols to be the modulated transmitted symbols.

3. The system of claim 1, wherein the reference symbols comprise demodulation reference signal information of the broadband cellular communication session.

4. The system of claim 1, wherein the data symbols comprise orthogonal frequency division multiplexing data symbols.

5. The system of claim 1, wherein the performing of the channel estimation is based on a time domain interpolation of the protocol data unit.

6. The system of claim 5, wherein the time domain interpolation is performed on at least some of the data symbols.

7. The system of claim 5, wherein performing the time domain interpolation is omitted with respect to the reference symbols.

8. The system of claim 1, wherein the performing of the channel estimation is based on a least squares estimation.

9. A method, comprising:
for a protocol data unit that comprises symbols, wherein the symbols comprise reference symbols and data symbols, wherein the protocol data unit is received as part of broadband cellular communications, while there are symbols of the symbols for which channel estimation has not yet been performed, and after initializing current symbols as the reference symbols, performing at least one iteration of,
performing, by a system comprising at least one processor, channel estimation over the current symbols, to produce a channel estimation, and adding the channel estimation to a cumulative channel estimation,
equalizing and decoding, by the system, new data symbols of the data symbols that satisfy a proximity criterion with respect to the current symbols based on the channel estimation, and to produce decoded new data symbols, wherein an iteration of the at least one iteration has not yet been performed for the new data symbols, and
based on determining that a cyclic redundancy check for the decoded new data symbols passes, and based on determining that there are the symbols for which channel estimation has not yet been performed, setting, by the system, the current symbols to be the decoded new data symbols, and performing another iteration of the at least one iteration; and
adapting, by the system, transmission parameters for the broadband cellular communications based on the cumulative channel estimation.

10. The method of claim 9, wherein the protocol data unit is a first protocol data unit, wherein the cyclic redundancy check is a first cyclic redundancy check, and further comprising:
halting, by the system, performing channel estimation for a second protocol data unit based on determining that a second cyclic redundancy check fails for a part of the second protocol data unit.

11. The method of claim 9, wherein the protocol data unit is received on a physical uplink shared channel of the broadband cellular communications.

12. The method of claim 9, wherein the protocol data unit is received on a physical downlink shared channel of the broadband cellular communications.

13. The method of claim 9, further comprising:
communicating, by the system, a number of the reference symbols per protocol data unit via scheduling information.

14. The method of claim 9, wherein the protocol data unit is a first protocol data unit, wherein the reference symbols are first reference symbols, and further comprising:
determining, by the system, a second number of second reference signals to use with a second protocol data unit, based on based on the cumulative channel estimation, wherein the second number differs from a first number of first reference signals of the first protocol data unit.

15. The method of claim 9, wherein the protocol data unit is a first protocol data unit, wherein the reference symbols are first reference symbols, and further comprising:
receiving, by the system, a second number of second reference signals to use with a second protocol data unit, based on based on the cumulative channel estimation, wherein the second number differs from a first number of first reference signals of the first protocol data unit.

16. A non-transitory computer-readable medium comprising instructions that, in response to execution, cause a system comprising at least one processor to perform operations, comprising:
for a protocol data unit that comprises symbols, wherein the symbols comprise reference symbols and data symbols, wherein the protocol data unit is received as part of broadband cellular communications, while there are symbols of the symbols for which channel estimation has not yet been performed, and after initializing current symbols as the reference symbols, performing at least one iteration of,
performing channel estimation over the current symbols, to produce a channel estimation, and adding the channel estimation to a cumulative channel estimation,
equalizing and decoding new data symbols of the data symbols that satisfy a proximity criterion with respect to the current symbols based on the channel estimation, and to produce decoded new data symbols, wherein an iteration of the at least one iteration has not yet been performed for the new data symbols, and
based on determining that a cyclic redundancy check for the decoded new data symbols passes, and based on determining that there are the symbols for which channel estimation has not yet been performed, setting the current symbols to be the decoded new data symbols, and performing another iteration of the at least one iteration; and
adapting transmission parameters for the broadband cellular communications based on the cumulative channel estimation.

17. The non-transitory computer-readable medium of claim 16, wherein the at least one iteration comprises:
remapping the current symbols.

18. The non-transitory computer-readable medium of claim 17, wherein the remapping is performed by a layer 1 hardware accelerator card.

19. The non-transitory computer-readable medium of claim 18, wherein the layer 1 hardware accelerator card is configured to perform remapping as part of performing successive-interference cancellation or as part of performing serial-interference cancellation.

20. The non-transitory computer-readable medium of claim 16, wherein the operations further comprise:
based on the determining that the cyclic redundancy check for the decoded new data symbols passes, performing cyclic redundancy check attachment, encoding, scrambling, rate matching, and modulating, to produce modulated transmitted symbols; and
wherein the setting of the current symbols to be the decoded new data symbols comprises setting the current symbols to be the modulated transmitted symbols.
